(19) United States
(12) Patent Application Publication
(10) Pub. No.: US 2026/0133661 A1
(43) Pub. Date: May 14, 2026

(54) TOUCH-PANEL EMBEDDED DISPLAY APPARATUS

(71) Applicant: Sharp Display Technology Corporation, Kameyama City, (JP)

(72) Inventors: Kazutoshi KIDA, Kameyama City (JP); Takenori MARUYAMA, Kameyama City (JP); Takuma YAMAMOTO, Kameyama City (JP); Shinji YAMAGISHI, Kameyama City (JP); Yasuhiro SUGITA, Kameyama City (JP)

(21) Appl. No.: 19/382,907

(22) Filed: Nov. 7, 2025

(30) Foreign Application Priority Data
Nov. 11, 2024 (JP) 2024-196875

(51) Int. Cl. G06F 3/044; G06F 3/041

(52) U.S. Cl. CPC G06F 3/0446; G06F 3/04164; G06F 3/0445; G06F 3/0448

(57) ABSTRACT

A display apparatus includes a pixel electrode, a counter electrode, a plurality of driving electrodes, and a plurality of detection electrodes. The counter electrode, the driving electrodes, and the detection electrodes are formed in the same layer. The detection electrodes form capacitance with the driving electrodes. The counter electrode includes a first portion arranged between the driving electrodes and a second portion arranged between the detection electrodes.

### BACKGROUND

### 1. Field

The present disclosure relates to a touch-panel embedded display apparatus.

### 2. Description of the Related Art

The touch-panel embedded display apparatus disclosed in Japanese Unexamined Patent Application Publication No. 2022-114180 includes multiple driving electrodes, multiple detection electrodes, multiple pixel electrodes, and a touch detection driver. The touch detection driver does not supply, during a first time period, a touch detection driving signal to a first driving electrode overlapping in a plan view a first pixel electrode group supplied with a gate signal but supplies the touch detection driving signal to a second driving electrode overlapping in a plan view a second pixel electrode group not supplied with the gate signal. During the first time period, the first driving electrode operates as an electrode for displaying (a counter electrode (common electrode) facing the pixel electrodes).

To increase in size the touch-panel embedded display apparatus disclosed in Japanese Unexamined Patent Application Publication No. 2022-114180, each driving electrode and each detection electrode may also be increased in size. The load of the driving electrodes (capacitance and resistance) and the load of the detection electrodes thus increase. An increase in the load may lead to difficulty in supplying the driving signal to the driving electrode. Specifically, enlarging the touch-panel embedded display apparatus may distort the waveform of the driving signal, making accurate touch detection difficult.

It is desirable to provide a touch-panel embedded display apparatus that is increased in size with the load of a driving electrode and the load of a detection electrode being reduced.

### SUMMARY

According to an aspect of the disclosure, there is provided a touch-panel embedded display apparatus including: a pixel electrode, a counter electrode arranged to face the pixel electrode and formed in a first layer, a plurality of driving electrodes formed in the first layer, and a plurality of detection electrodes formed in the first layer and forming capacitance with the driving electrodes. The counter electrode includes a first portion arranged between the driving electrodes and a second portion arranged between the detection electrodes.

### BRIEF DESCRIPTION OF THE DRAWINGS

FIG. 1 is a block diagram illustrating the functional configuration of a display apparatus of a first embodiment;

FIG. 2 is a cross-sectional view of a touch panel;

FIG. 3 is a cross-sectional view of the touch pane;

FIG. 4 is a schematic plan view that illustrates how a gate driver, source driver, and thin-fil transistors are connected to each other;

FIG. 5 is a schematic circuit diagram that illustrates how the thin-film transistor, gate line, and source line are connected;

FIG. 6 is a schematic plan view that illustrates the layout of driving electrodes and gate lines;

FIG. 7 illustrates the configuration of a gate line group;

FIG. 8 is a plan view illustrating the layout of the driving electrodes, detection electrodes, and counter electrodes;

FIG. 9 illustrates a unit cell;

FIG. 10 is a timing diagram illustrating timings of transmitting a gate signal and driving signal in the first embodiment;

FIG. 11 illustrates the configuration of a touch panel in a display apparatus in a second embodiment;

FIG. 12 illustrates the configuration of a driving electrode in the second embodiment;

FIG. 13 is a cross-sectional view illustrating the configuration of a touch panel serving as a comparative example;

FIG. 14 is a cross-sectional view illustrating the configuration of a touch panel in the second embodiment;

FIG. 15 is a plan view illustrating the configuration of a touch panel in a first modification of the second embodiment; and

FIG. 16 is a plan view illustrating the configuration of a touch panel in a second modification of the second embodiment.

### DESCRIPTION OF THE EMBODIMENTS

Embodiments of the disclosure are described in detail below with reference to the drawings. Elements that are the same as each other or identical to each other are designated with the same reference numerals and the discussion thereof is not repeated. To clarify the discussion, the drawings that are referenced below may be simplified, or schematized, or some elements may be omitted. The dimension ratio between the elements in each of the drawings may not be an actual dimension ratio.

### First Embodiment

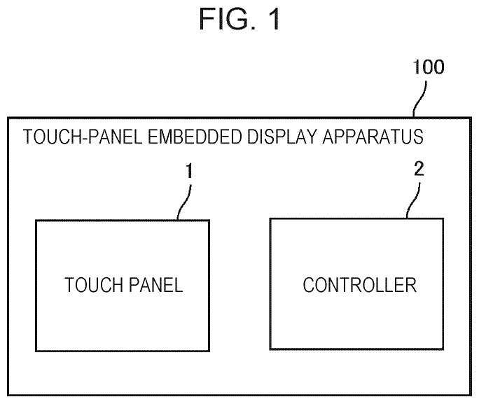

The configuration of a touch-panel embedded display apparatus 100 of a first embodiment (hereinafter referred to as a display apparatus 100) is described below. FIG. 1 is a block diagram illustrating the functional configuration of the display apparatus 100 of the first embodiment.

Referring to FIG. 1, the display apparatus 100 includes a touch panel 1 and controller 2. The touch panel 1 is a full-in-cell type touch panel. The touch panel 1 operates as a display panel that displays a video or an image. The controller 2 performs a control operation on the display apparatus 100 in accordance with touch detection information (for example, a touch position) acquired from the touch panel 1.

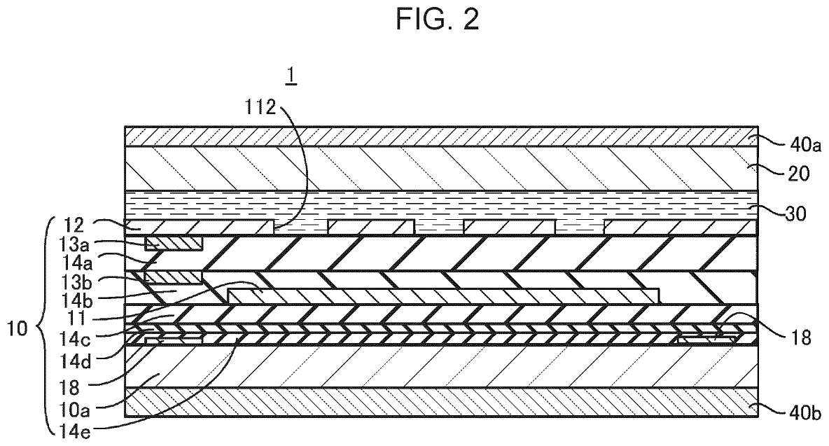

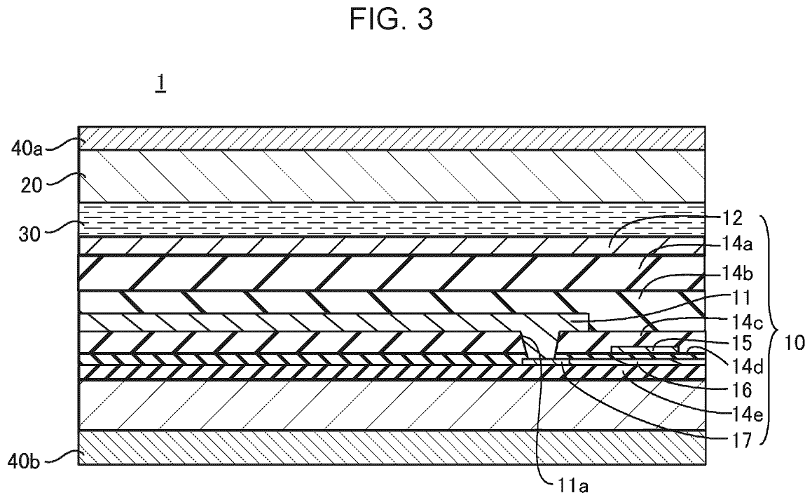

FIGS. 2 and 3 are cross-sectional views of the touch panel 1. As illustrated in FIG. 2, the touch panel 1 includes an active matrix substrate 10, counter substrate 20, and liquid-crystal layer 30 interposed between the active matrix substrate 10 and the counter substrate 20. A pair of polarizing plates 40a and 40b are arranged to sandwich the active matrix substrate 10 and counter substrate 20. A color filter (not illustrated) is arranged on the counter substrate 20. A protective glass or the like (not illustrated) is mounted on the surface of the polarizing plate 40a. The outermost layer, such as the protective glass, forms a touch surface (a surface that a pointer touches). A user may recognize an image on the surface of the polarizing plate 40a. The touch panel 1 receives on the touch surface a touch operation of a finger (pointer) or the like.

Liquid-crystal molecules contained in the liquid-crystal layer 30 in the touch panel 1 are driven in in-plane switching method. To perform in-plane switching, the active matrix substrate 10 includes, as illustrated in FIG. 2, pixel electrodes 11 and electrodes 12 that form electric fields. Each electrode 12 is one of a driving electrode 12a, detection electrode 12b, and counter electrode 12c. When the driving electrode 12a, detection electrode 12b, and counter electrode 12c are not differentiated from each other, the electrodes are referred to as the electrodes 12. The electrode 12 operates as a common electrode that faces multiple pixel electrodes 11. The electrode 12 is thus arranged to be common to the pixel electrodes 11. Referring to FIG. 2, the electrode 12 has one or more slits 112.

Referring to FIG. 2, the active matrix substrate 10 includes the electrode 12, first touch signal line 13a, first insulation layer 14a, second touch signal line 13b, second insulation layer 14b, pixel electrode 11, third insulation layer 14c, gate line 15 (see FIG. 3), fourth insulation layer 14d, semiconductor layer 16 (see FIG. 3), drain electrode 17 (see FIG. 3), fifth insulation layer 14e, source line 18, and glass substrate 10a, arranged from the touch surface the electrode 12 in that order. The electrode 12 is arranged to overlap the pixel electrode 11 in a plan view.

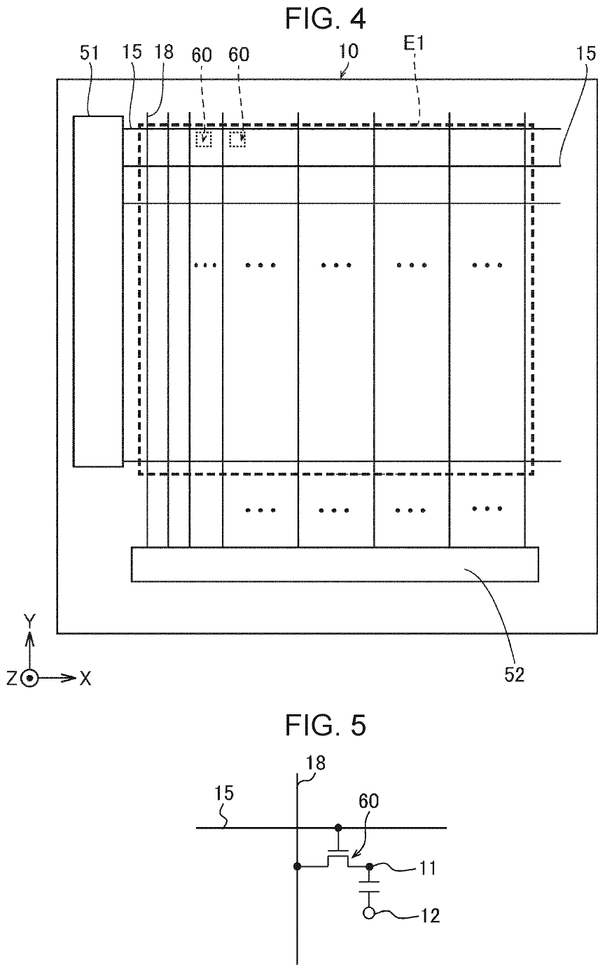

FIG. 4 is a schematic plan view that illustrates how a gate driver 51, source driver 52, and thin-film transistors 60 are connected. The active matrix substrate 10 includes the gate driver 51 and source driver 52. Multiple gate lines 15 and multiple source lines 18 mutually intersect in a grid pattern. Referring to FIG. 4, thin-film transistors 60 are respectively arranged in regions surrounded by the gate lines 15 and source lines 18.

FIG. 5 is a schematic circuit diagram illustrating how the thin-film transistor 60, gate line 15, and source line 18 are connected. Referring to FIG. 5, the gate electrode of the thin-film transistor 60 is connected to the gate line 15, and the source electrode of the thin-film transistor 60 is connected to the source line 18. The drain electrode of the thin-film transistor 60 is connected to the pixel electrode 11 via a contact hole 11a (see FIG. 3).

The gate lines 15 connect each of the thin-film transistors 60 to the gate driver 51. The source lines 18 connect each of the thin-film transistors 60 to the source driver 52. The gate driver 51 and source driver 52 are respectively arranged on frame regions outside a display region E1 (see FIG. 4) where the pixel electrodes 11 are arranged. The gate driver 51 may be manufactured by (monolithically) forming a circuit on the glass substrate 10a or manufactured of an integrated circuit. The source driver 52 is manufactured of, for example, an integrated circuit. The gate driver 51 successively supplies a gate signal (scanning signal) to the gate lines 15. Specifically, the gate driver 51 successively supplies a voltage to the gate lines 15 at a specific frequency (for scanning) in accordance with a horizontal synchronization signal from the controller 2. The source driver 52 supplies a source signal (data signal) to each of the source lines 18.

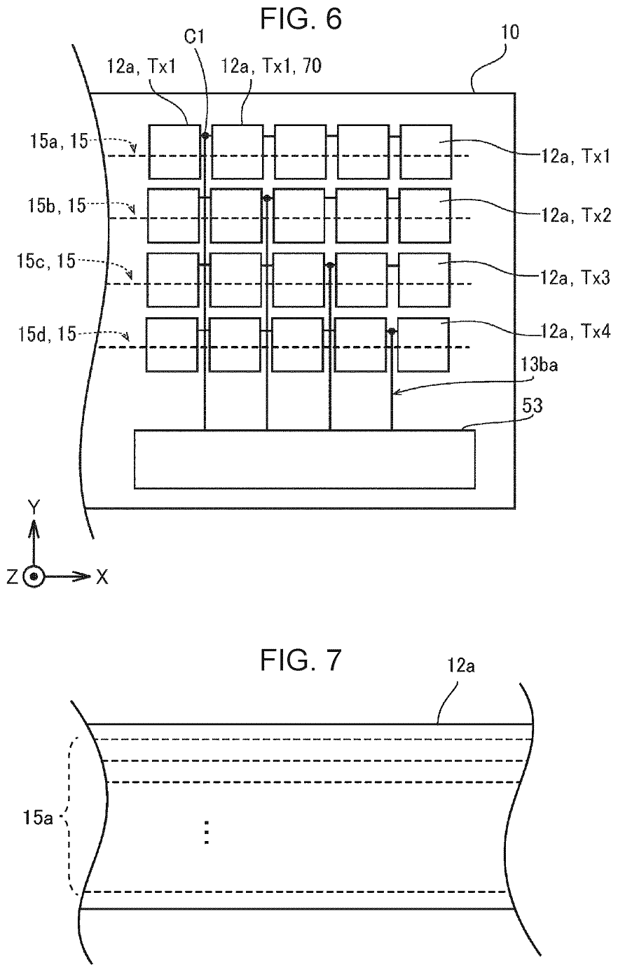

FIG. 6 is a schematic plan view that illustrates the layout of driving electrodes 12a and gate lines 15. For convenience of explanation, the driving electrode 12a is simply illustrated to be in a rectangular shape as illustrated in FIG. 6. The active matrix substrate 10 includes a touch detection driver 53. The touch detection driver 53 includes an integrated circuit that performs a control operation for touch detection. The touch detection driver 53 supplies the driving signal dm to the driving electrodes 12a via a first touch signal line 13a and second touch signal line 13b (wiring 13ba). The touch detection driver 53 acquires a detection signal from multiple detection electrodes 12b via the first touch signal line 13a. Specifically, the touch panel 1 may perform touch detection through mutual capacitance method. Note that the touch panel 1 may be configured to perform touch detection through not only the mutual capacitance method but also through self-capacitance method (self-sensing method). In the touch detection through the mutual capacitance method, the touch panel 1 detects touch position with a unit cell 70 serving as a pair of coordinates (node) as described below.

The driving electrode 12a respectively serve as a transmitter electrode (Tx) supplied with the driving signal dm. The driving electrodes 12a are arranged in a direction of extension (X direction) of the gate line 15 (see FIG. 6) and in a direction (Y direction) perpendicular to the X direction. For convenience of explanation, FIG. 6 illustrates four rows of driving electrodes 12a (20 driving electrodes 12a) but the number of driving electrodes 12a is not limited to 20.

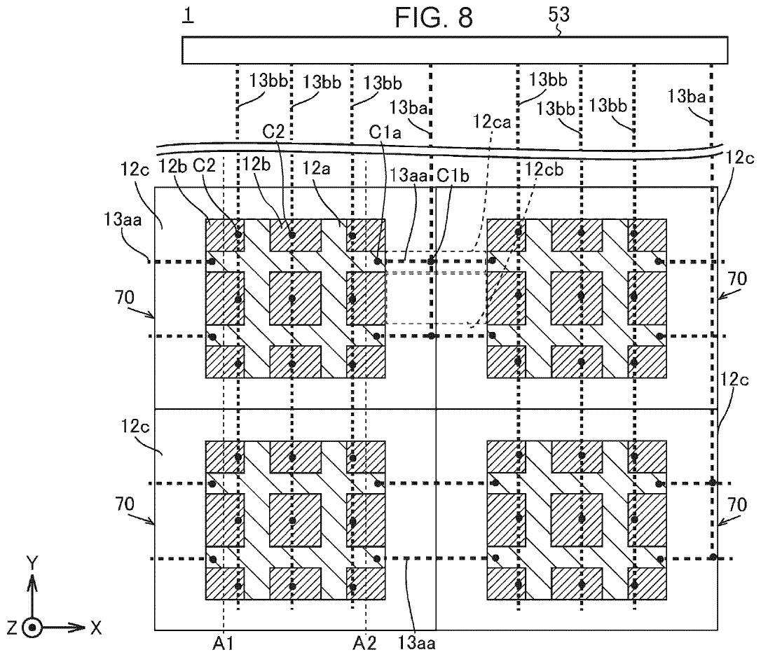

Referring to FIG. 6, the driving electrodes 12a are referred to as Tx1, Tx2, Tx3, and Tx4 successively arranged in that order from above. The gate lines 15 includes the gate line groups 15a, 15b, 15c, and 15d successively arranged in that order from above as illustrated in FIG. 6. Tx1, Tx2, Tx3, and Tx4 are arranged to respectively overlap the gate line groups 15a, 15b, 15c, and 15d in a plan view. FIG. 7 illustrates the configuration of the gate line group 15a. Although the gate line group 15a includes multiple gate lines 15 as illustrated in FIG. 7, the gate line group 15a is illustrated as a single line as illustrated in FIG. 6 for convenience of explanation.

FIG. 8 is a plan view that illustrates the layout of the driving electrodes 12a, detection electrodes 12b, and counter electrodes 12c. Referring to FIG. 8, the electrodes 12 include the driving electrodes 12a, detection electrodes 12b, and counter electrodes 12c. The driving electrodes 12a, the detection electrodes 12b, and the counter electrodes 12c are formed in the same layer and manufactured of the same material (for example, Indium Tin Oxide (ITO)). The first touch signal lines 13a include wirings 13aa connected to the driving electrodes 12a. The second touch signal lines 13b include wirings 13bb connected to the detection electrodes 12b, wirings (not illustrated) connected to the counter electrodes 12c, and wirings 13ba that are connected to the wirings 13aa via the contact hole C1b and connected to the touch detection driver 53. The electrodes 12 may be manufactured of a material (for example, a metal (copper, silver or gold)) other than ITO. The first touch signal lines 13a and the second touch signal lines 13b are manufactured of, for example, a metal (copper, silver or gold).

As illustrated in FIG. 6, a portion of the counter electrode 12c is arranged between the driving electrodes 12a arranged side by side in the X direction. The driving electrodes 12a are connected to wirings 13aa via contact holes C1a. The driving electrodes 12a arranged side by side in the X direction are connected to each other via the wiring 13aa. The driving electrode 12a has a grid pattern including a portion extending in the X direction and a portion extending in the Y direction. The driving electrodes 12a are supplied successively row by row with a driving signal (with each row of driving electrodes 12a extending in the X direction).

Multiple detection electrodes 12b are arranged to fill gaps in the grid pattern of the driving electrodes 12a. Each detection electrode 12b is connected to the wiring 13bb via a contact hole C2. As illustrated in FIG. 8, the wiring 13bb is connected to the detection electrode 12b at a location on a far side of a center location A1 (or center location A2) from the wiring 13aa in the X direction. Specifically, the wiring 13bb is arranged to be at a location spaced from the wiring 13aa (spaced from the wiring 13aa by at least one pixel). The detection electrode 12b forms capacitance with the driving electrode 12a. When a pointer is present between the detection electrode 12b and driving electrode 12a in this arrangement, the value of capacitance varies and a detection signal including information on the variation is input to the touch detection driver 53. The touch detection driver 53 determines the presence or absence of a touch of the pointer in response to the detection signal from the detection electrode 12b and detects a position of the touch.

The counter electrode 12c is formed to be rectangular (quadrilateral), surrounding the driving electrode 12a and detection electrodes 12b in a plan view. The counter electrode 12c includes a first portion 12ca formed between two adjacent driving electrodes 12a and a second portion 12cb formed between two adjacent detection electrodes 12b. The counter electrode 12c is supplied with a voltage to generate an electric field with the pixel electrode 11.

Since each counter electrode 12c is electrically isolated from the driving electrodes 12a and detection electrodes 12b, capacitance, resistance and the like of the counter electrode 12c do not serve as a load on the driving electrodes 12a and detection electrodes 12b. According to the first embodiment, the contact hole C1b and the wiring 13ba are arranged at locations that overlap the first portion 12ca of the counter electrode 12c. In comparison with the case in which the contact hole C1b and the wiring 13ba are arranged at locations that overlap the detection electrode 12b, the loads of the contact hole C1b and wiring 13ba may be reduced and variations in the capacitance of the entire surface of the touch panel 1 may be reduced. The wiring 13ba is arranged at a location that is spaced from the detection electrode 12b (spaced from the detection electrode 12b by at least one pixel). The capacitance formed between the wiring 13ba and the detection electrode 12b may thus be reduced. If one detection electrode is arranged closer to a wiring, that detection electrode has a larger capacitance than another detection electrode, leading to variations in the capacitance between the detection electrodes in a touch panel. In contrast, according to the first embodiment, the wiring 13ba is arranged to be spaced from the detection electrode 12b, variations in the capacitances of the detection electrodes 12b may be controlled in the touch panel 1. As a result, the sensitivities of the touch detection in the touch panel 1 are homogenized and the sensitivity of the whole touch panel 1 may thus be increased. Each driving electrode 12a is not identical in shape to each detection electrode 12b and the balance between the performance of the touch detection and the magnitude of load may thus be adjusted by modifying at least one of the driving electrode 12a and the detection electrode 12b in terms of size.

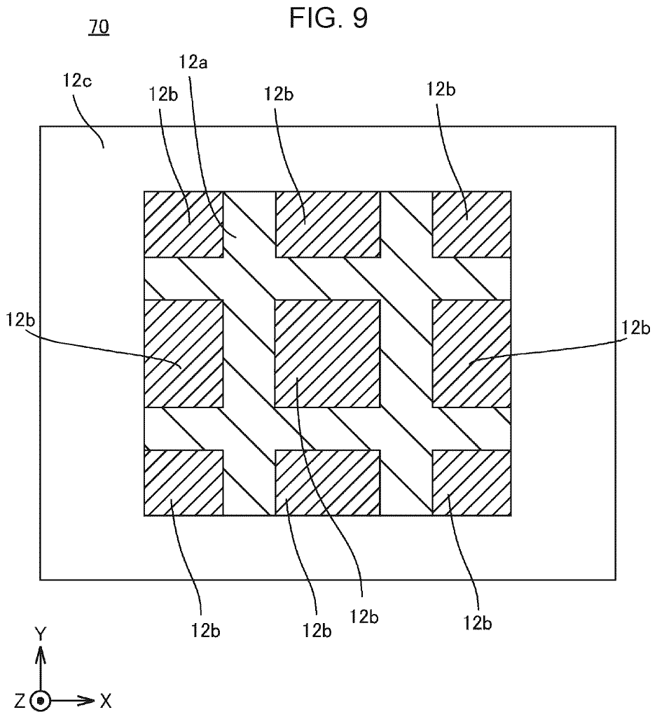

FIG. 9 illustrates a unit cell 70. Referring to FIG. 9, the driving electrode 12a, nine detection electrodes 12b, and counter electrode 12c form a single pair of coordinates (the unit cell 70) in touch position detection. Since the counter electrode 12c is included in a single unit cell 70, the area of the driving electrode 12a and nine detection electrodes 12b per unit cell 70 is smaller and the load of the touch panel 1 is reduced.

### Control Method in First Embodiment

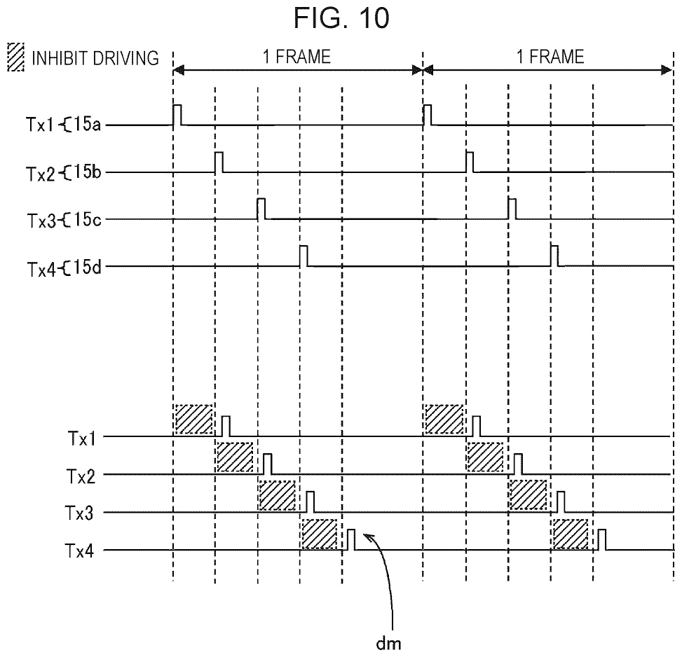

Control method of the display apparatus 100 in the first embodiment is described below with reference to FIG. 10. FIG. 10 is a timing diagram illustrating timings of a gate signal and driving signal dm in the first embodiment. The display apparatus 100 of the first embodiment operates in a mask drive system. Specifically, the touch detection driver 53, while the gate line 15 overlapping one of the driving electrodes 12a is supplied with the gate signal, supplies another one of the driving electrodes 12a with the driving signal dm. While the gate line 15 overlapping one of the detection electrodes 12b is supplied with the gate signal, the touch detection driver 53 supplies at least one of the driving electrodes 12a with the driving signal dm.

As illustrated in FIG. 10, for example, the gate line groups 15a through 15d are successively supplied with the gate signal within a time period of one frame (within one period of a vertical synchronization signal). While the gate line group 15a overlapping Tx1 (see FIG. 6) in a plan view is supplied with the gate signal, Tx1 is not supplied with the driving signal dm (Tx1 is inhibited from being driven). While the gate line group 15b overlapping Tx2 in a plan view is supplied with the gate signal, Tx2 is not supplied with the driving signal dm (Tx2 is inhibited from being driven) and Tx1 is supplied with the driving signal dm. While the gate line group 15c overlapping Tx3 in a plan view is supplied with the gate signal, Tx3 is not supplied with the driving signal dm and Tx2 is supplied with the driving signal dm. While the gate line group 15d overlapping Tx4 in a plan view is supplied with the gate signal, Tx4 is not supplied with the driving signal dm and Tx3 is supplied with the driving signal dm. During a pause period after Tx3 is supplied with the driving signal dm (a time period throughout which none of the gate line groups 15a through 15d is supplied with the driving signal dm), Tx4 is supplied with the driving signal dm.

The touch detection driver 53 detects a touch of the pointer, such as a finger, in accordance with the detection signal acquired from each of the detection electrodes 12b. For example, the touch detection driver 53 adds detection signals acquired from each of the detection electrodes 12b within the time period of one frame. The touch detection driver 53 acquires a touch position in accordance with the added data (data in the form of a map). The touch detection driver 53 outputs the touch position to the controller 2. In this method, the effect of the touch detection on displaying and the effect of displaying on the touch detection may be controlled in the touch detection and the displaying and the touch detection may thus be concurrently performed.

### Second Embodiment

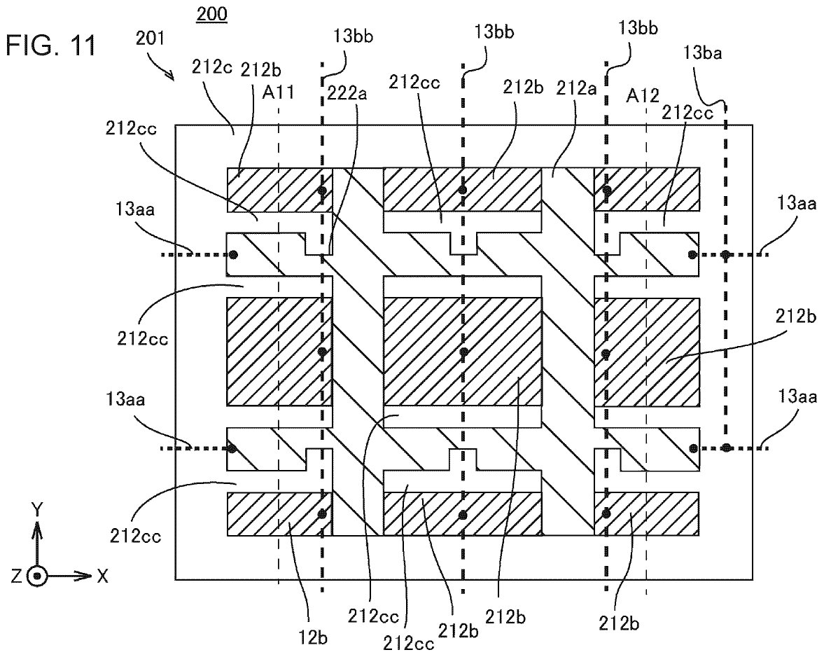

Configuration of a touch-panel embedded display apparatus 200 (hereinafter referred to as “display apparatus 200”) of a second embodiment is described with reference to FIGS. 11 through 14. A third portion 212cc of a counter electrode 212c is arranged between a driving electrode 212a and a detection electrode 212b in the display apparatus 200 of the second embodiment. The same reference numeral as in the first embodiment in the following discussion indicates the same configuration as in the first embodiment and unless otherwise noted, the previous discussion is applicable.

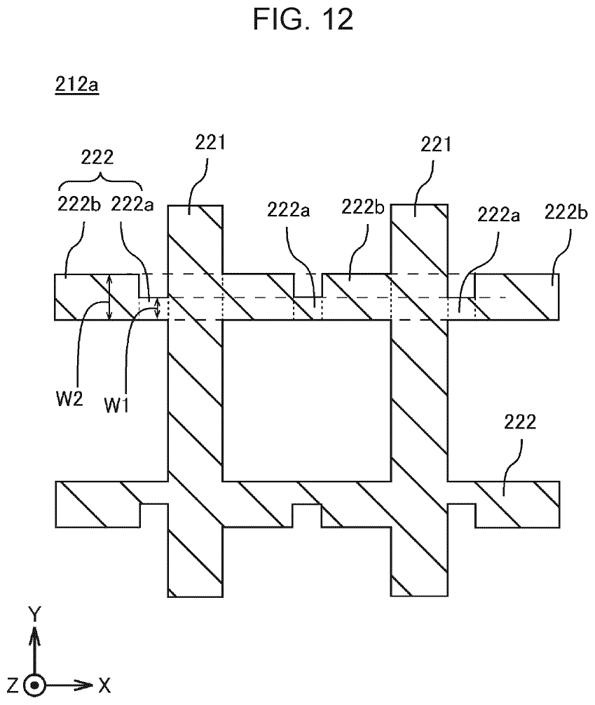

FIG. 11 illustrates the configuration of a touch panel 201 in the display apparatus 200 of the second embodiment. FIG. 12 illustrates the configuration of the driving electrode 212a of the second embodiment. Referring to FIG. 11, the display apparatus 200 includes the touch panel 201. The touch panel 201 includes the driving electrode 212a, detection electrodes 212b, and counter electrode 212c. Referring to FIG. 12, the driving electrode 212a has a grip pattern having a portion 221 extending in the vertical direction (Y direction) and a portion 222 extending in the horizontal direction (X direction). Referring to FIG. 11, the portion 222 includes a portion 222a overlapping a portion of a wiring 13bb in a plan view and a portion 222b not overlapping the portion of the wiring 13bb in a plan view.

The width W1 of the portion 222a in the direction of extension of the wiring 13bb (Y direction) is narrower than the width W2 of the portion 222b as illustrated in FIG. 12. This may lead to reducing the capacitance between the driving electrode 212a and the wiring 13bb. As a result, the capacitance not contributing to the touch detection may be reduced.

Referring to FIG. 11, the wiring 13bb is connected to the detection electrode 212b at a location on a far side of a center location A11 (or A12) from the wiring 13aa in the direction of extension of the wiring 13aa. This arrangement may lead to reducing the capacitance between the wiring 13aa and the wiring 13bb. As a result, the capacitance not contributing to the touch detection may be reduced.

Referring to FIG. 11, the counter electrode 212c includes a third portion 212cc arranged between the portion 222 of the driving electrode 12a and the detection electrode 212b.

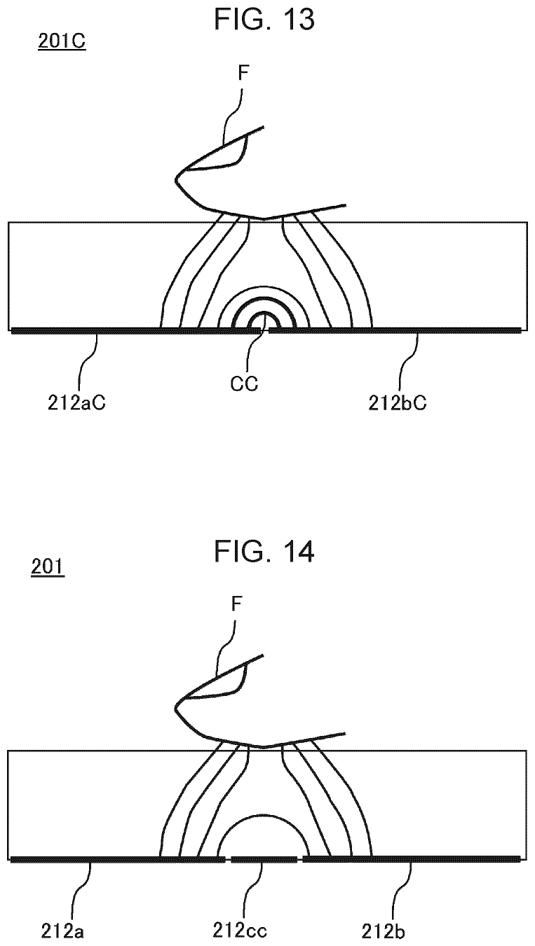

FIG. 13 is a cross-sectional view illustrating the configuration of a touch panel 201C serving as a comparative example. FIG. 14 is a cross-sectional view illustrating the configuration of the touch panel 201 of the second embodiment. A driving electrode 212aC and detection electrode 212bC are arranged to be adjacent to each other in the touch panel 201C as the comparative example as illustrated in FIG. 13. A higher capacitive coupling CC is created between the driving electrode 212aC and detection electrode 212bC regardless of whether a pointer F touches the touch panel 201C. The capacitance caused by the capacitive coupling CC does not vary regardless of the presence or absence of touching and thus does not contribute to the touch detection. In contrast as illustrated in FIG. 14, the third portion 212cc is arranged between the driving electrode 212a and detection electrode 212b in the touch panel 201 of the second embodiment. Capacitive coupling not contributing to the touch detection between the driving electrode 212a and detection electrode 212b is thus reduced and the capacitance not varying depending on the presence or absence of touching may thus be reduced. In this way, a component contributing to the touch detection in detection signals may be increased.

### Modifications

The embodiments described above and modifications are described for exemplary purposes only. The disclosure is not limited to the embodiments and the embodiments may be appropriately modified without departing from the scope of the disclosure.

(1) According to the first and second embodiments, the counter electrode is arranged to surround the driving electrode and detection electrode. The disclosure is not limited to this configuration. For example, the counter electrode may be arranged on the side of the driving electrode or the side of the detection electrode.

(2) According to the first and second embodiments, the first touch signal line is arranged in a layer higher than the second touch signal line. The disclosure is not limited to this configuration. For example, the first touch signal line may be arranged in a layer lower than the second touch signal line.

(3) According to the first and second embodiments, the driving electrodes are arranged in a grid pattern and the detection electrodes are formed to be rectangular. The disclosure is not limited to this configuration. The driving electrodes may be formed to be in a rectangular shape, a circular shape or a frame shape. The detection electrodes may be arranged in a grid pattern and may be formed to be in a circular shape.

(4) According to the first and second embodiments, the contact hole C1b connecting the wiring 13aa to the wiring 13ba is arranged at a location overlapping the counter electrode 12c in a plan view. The disclosure is not limited to this configuration. For example, the contact hole C1b may be arranged at a location overlapping the driving electrode 12a or the detection electrode 12b in a plan view.

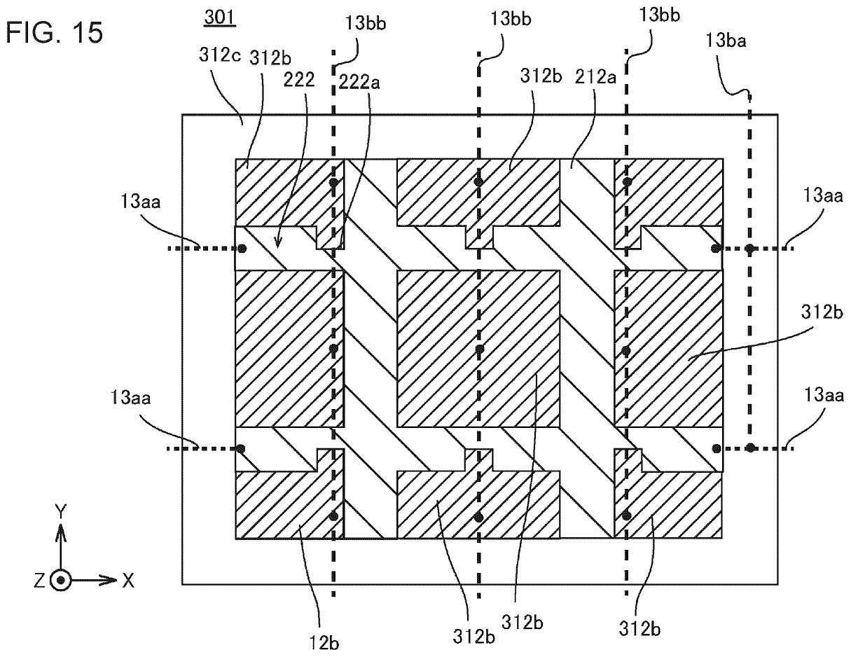

(5) According to the second embodiment, the third portion 212cc is arranged in the counter electrode 212c. The disclosure is not limited to this configuration. For example, in a touch panel 301 of a first modification of the second embodiment illustrated in FIG. 15, the third portion 212cc is not arranged in a counter electrode 312c and the portion 222 of the driving electrode 212a is adjacent to the detection electrode 312b.

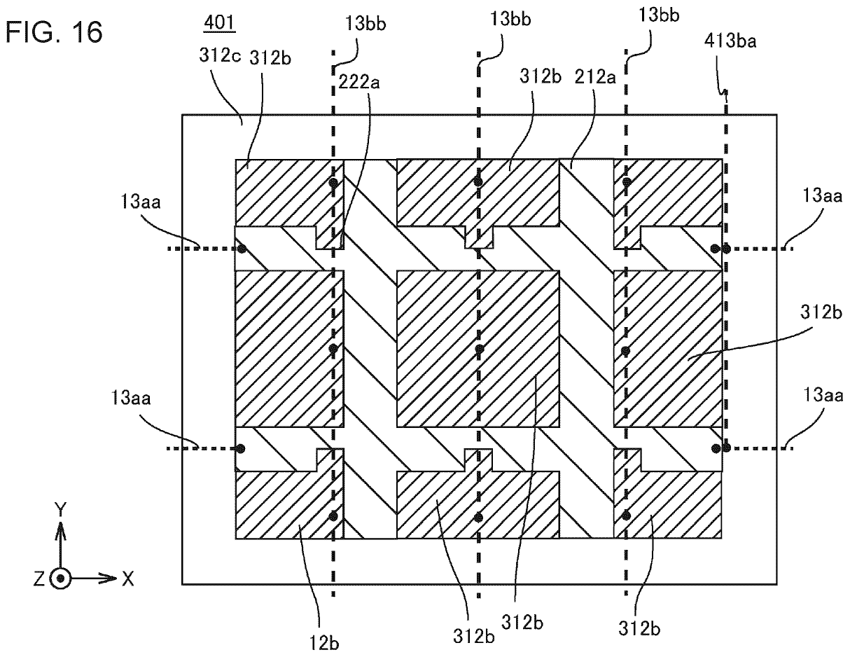

(6) According to the first and second embodiments, the wiring 13ba is arranged to be spaced from the detection electrode 12b by at least one pixel. The disclosure is not limited to this configuration. For example, in a touch panel 401 of a second modification of the second embodiment illustrated in FIG. 16, a wiring 413ba is arranged at a location adjacent to the detection electrode 312b in a plan view.

(7) According to the first and second embodiments, the touch panel operates in the mask drive system but the disclosure is not limited to this configuration. Image displaying and touch detection may be performed in a time-division method by separating a time period of displaying image from a time period of performing touch detection on the touch panel.

The configurations described above may also be described as below.

A touch-panel embedded display apparatus in a first configuration includes: a pixel electrode, a counter electrode arranged to face the pixel electrode and formed in a first layer, a plurality of driving electrodes formed in the first layer, and a plurality of detection electrodes formed in the first layer and forming capacitance with the driving electrodes. The counter electrode includes a first portion arranged between the driving electrodes and a second portion arranged between the detection electrodes (first configuration).

According to the first configuration, the first portion of the counter electrode arranged between the driving electrodes and the second portion of the counter electrode arranged between the detection electrodes may lead to reducing the size of each driving electrode and the size of each detection electrode. In this way, the load of the driving electrode and the load of the detection electrode may be reduced. A reduction in the load of the driving electrode and a reduction in the load of the detection electrode may lead to increasing the touch-panel embedded display apparatus in size.

The touch-panel embedded display apparatus in the first configuration may further include a driving electrode connection wiring that connects the driving electrodes and is formed in a second layer different from the first layer (second configuration).

According to the second configuration, the driving electrodes are electrically connected to each other via the driving electrode connection wiring even when the first portion of the counter electrode is arranged between the driving electrodes.

The touch-panel embedded display apparatus in the second configuration may further include a driving signal supply wiring that is connected to the driving electrode connection wiring at a location overlapping the counter electrode in a plan view and a driving signal supply circuit that supplies a driving signal to the driving electrodes via the driving signal supply wiring (third configuration).

According to the third configuration, an increase in the capacitance between the detection electrode and the driving signal supply wiring may be controlled in comparison with the case in which the driving signal supply wiring overlaps the detection electrode in a plan view.

In the touch-panel embedded display apparatus in one of the first through third configurations, the counter electrode may surround at least one of the driving electrodes and at least one of the detection electrodes (fourth configuration). The counter electrode in the fourth configuration may surround the detection electrodes (fifth configuration).

According to one of the fourth and fifth configurations, the counter electrode not used in the touch detection is arranged to surround at least one of the driving electrodes or at least one of the detection electrodes and the effect of the counter electrode on the touch detection may thus be controlled.

The touch-panel embedded display apparatus in one of the first through fifth configurations may further include a plurality of thin-film transistors, a plurality of gate lines that are connected to the thin-film transistors, extends in a first direction, and are arranged side by side in a second direction perpendicular to the first direction, a gate driving control circuit that successively supplies the gate lines with a gate signal, and a driving signal supply circuit that supplies the driving electrodes with a driving signal. The driving electrodes may include a plurality of driving electrode groups that are arranged side by side in the second direction. Each of the driving electrode groups may be arranged to overlap one of the gate lines. The driving signal supply circuit, while the one of the gate lines that is overlapped by one of the driving electrode groups is supplied with the gate signal, supplies the driving signal to another one of the driving electrode groups (sixth configuration).

According to the sixth configuration, the touch-panel embedded display apparatus may concurrently perform image displaying and touch detection.

The touch-panel embedded display apparatus in one of the first through sixth configurations may further include a detection electrode connection wiring that connects the detection electrodes and is formed in a third layer different from the first layer (seventh configuration).

According to the seventh configuration, the detection electrodes are electrically connected to each other via the detection electrode connection wiring even when the second portion of the counter electrode is arranged between the detection electrodes.

At least one of the driving electrodes in the seventh configuration may include a portion overlapping a portion of the detection electrode connection wiring in a plan view and a portion not overlapping the portion of the detection electrode connection wiring in a plan view. A length of the portion overlapping the portion of the detection electrode connection wiring in the plan view may be shorter in a direction of extension of the detection electrode connection wiring than a length of the portion not overlapping the portion of the detection electrode connection wiring in the plan view (eighth configuration).

According to the eighth configuration, the capacitance between the driving electrode and the detection electrode connection wiring may be set to be smaller. As a result, capacitance not contributing to the touch detection may be set to be smaller.

The touch-panel embedded display apparatus in one of the seventh and eighth configurations may further include a driving electrode connection wiring connecting the driving electrodes and formed in a second layer different from the first layer. The detection electrode connection wiring may be connected to the detection electrode at a location on a far side of a center location in a direction of extension of the driving electrode connection wiring from the driving electrode connection wiring (ninth configuration).

According to the ninth configuration, the capacitance between the driving electrode connection wiring and the detection electrode connection wiring may be set to be smaller. As a result, capacitance not contributing to the touch detection may be set to be smaller.

The counter electrode in one of the first through ninth configurations may further include a third portion that is arranged between at least one of the driving electrodes and at least one of the detection electrodes (tenth configuration).

When the driving electrode and detection electrode are arranged to be closer to each other, the capacitance formed in the vicinity of the border between the driving electrode and detection electrode does not contribute to the touch detection. Specifically, since the distance between the driving electrode and detection electrode becomes shorter than the distance between the driving electrode and pointer or the distance between the detection electrode and pointer, the capacitance depending on the presence or absence of the pointer becomes smaller than the capacitance formed in the vicinity (unchanging capacitance). According to the tenth configuration, the third portion of the counter electrode arranged between the driving electrode and detection electrode may cause the distance between the driving electrode and detection electrode to be longer. As a result, the capacitance not contributing to the touch detection may thus be set to be smaller.

The present disclosure contains subject matter related to that disclosed in Japanese Priority Patent Application JP 2024-196875 filed in the Japan Patent Office on Nov. 11, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A touch-panel embedded display apparatus comprising:
a pixel electrode, a counter electrode arranged to face the pixel electrode and formed in a first layer, a plurality of driving electrodes formed in the first layer, and a plurality of detection electrodes formed in the first layer and forming capacitance with the driving electrodes, the counter electrode including a first portion arranged between the driving electrodes and a second portion arranged between the detection electrodes.

2. The touch-panel embedded display apparatus according to claim 1, further comprising a driving electrode connection wiring that connects the driving electrodes and is formed in a second layer different from the first layer.

3. The touch-panel embedded display apparatus according to claim 2, further comprising a driving signal supply wiring that is connected to the driving electrode connection wiring at a location overlapping the counter electrode in a plan view and a driving signal supply circuit that supplies a driving signal to the driving electrodes via the driving signal supply wiring.

4. The touch-panel embedded display apparatus according to claim 1, wherein the counter electrode surrounds at least one of the driving electrodes and at least one of the detection electrodes.

5. The touch-panel embedded display apparatus according to claim 4, wherein the counter electrode surrounds the detection electrodes.

6. The touch-panel embedded display apparatus according to claim 1, further comprising a plurality of thin-film transistors, a plurality of gate lines that are connected to the thin-film transistors, extends in a first direction, and are arranged side by side in a second direction perpendicular to the first direction, a gate driving control circuit that successively supplies the gate lines with a gate signal, and a driving signal supply circuit that supplies the driving electrodes with a driving signal, wherein the driving electrodes include a plurality of driving electrode groups that are arranged side by side in the second direction, each of the driving electrode groups is arranged to overlap one of the gate lines, and the driving signal supply circuit, while the one of the gate lines that is overlapped by one of the driving electrode groups is supplied with the gate signal, supplies the driving signal to another one of the driving electrode groups.

7. The touch-panel embedded display apparatus according to claim 1, further comprising a detection electrode connection wiring that connects the detection electrodes and is formed in a third layer different from the first layer.

8. The touch-panel embedded display apparatus according to claim 7, wherein at least one of the driving electrodes comprises a portion overlapping a portion of the detection electrode connection wiring in a plan view and a portion not overlapping the portion of the detection electrode connection wiring in a plan view, and wherein a length of the portion overlapping the portion of the detection electrode connection wiring in the plan view is shorter in a direction of extension of the detection electrode connection wiring than a length of the portion not overlapping the portion of the detection electrode connection wiring in the plan view.

9. The touch-panel embedded display apparatus according to claim 7, further comprising a driving electrode connection wiring connecting the driving electrodes and formed in a second layer different from the first layer, wherein the detection electrode connection wiring is connected to the detection electrode at a location on a far side of a center location in a direction of extension of the driving electrode connection wiring from the driving electrode connection wiring.

10. The touch-panel embedded display apparatus according to claim 1, wherein the counter electrode further comprises a third portion that is arranged between at least one of the driving electrodes and at least one of the detection electrodes.
